(19) United States
(12) Patent Application Publication
(10) Pub. No.: US 2022/0019405 A1
(43) Pub. Date: Jan. 20, 2022

(54) METHOD AND APPARATUS FOR CONTROLLING SOUND QUALITY BASED ON VOICE COMMAND

(71) Applicant: DREAMUS COMPANY, Seoul (KR)

(72) Inventor: Seung Ho YU, Incheon (KR)

(21) Appl. No.: 17/370,846

(22) Filed: Jul. 8, 2021

(30) Foreign Application Priority Data
Jul. 14, 2020 (KR) 10-2020-0086956

(51) Int. Cl. G06F 3/16; G10L 15/22

(52) U.S. Cl. CPC G06F 3/167; G10L 2015/223; G06F 3/165; G10L 15/22

(57) ABSTRACT

Disclosed are a method for controlling a sound quality based on a voice command and an apparatus therefor. According to an exemplary embodiment of the present disclosure, a sound quality control method based on a voice command includes a voice command acquiring step of acquiring a voice command for playing media contents, a voice command analyzing step of recognizing the media contents by analyzing the voice command and generating recognition result information for the media contents, a category determining step of determining a category for the media contents based on the recognition result information, and a sound quality setting control step of determining a play sound quality mode of the media contents based on a determination result of the category.

### CROSS-REFERENCE TO RELATED APPLICATIONS

This application claims priority to and the benefit of Korean Patent Application No. 10-2020-0086956 filed in the Korean Intellectual Property Office on Jul. 14, 2020, the entire contents of which are incorporated herein by reference.

### BACKGROUND

### Field

The present disclosure relates to a method for controlling a play sound quality mode for playing contents based on a voice command and an apparatus therefor.

### Description of the Related Art

The contents described in this section merely provide background information on the exemplary embodiment of the present disclosure, but do not constitute the related art. In accordance with the development of a voice recognition technique, a voice command is being frequently used to play media contents.

Generally, even though a device of playing media contents (for example, a TV, a radio, or MP3) recognizes a voice command to play media contents, a sound quality mode (equalizer) in accordance with a type of media contents to be played is manually set. For example, when a user watches a movie using a voice command, the media content playing device may play the movie by analyzing the voice command, but a sound quality mode for the movie needs to be manually set by the manipulation of the user.

In other word, generally, there are problems in that the sound quality mode needs to be manually selected for the media content selected by the user and the user needs to manually manipulate the sound quality mode whenever the type of media content is changed. Further, the selected sound quality mode is not optimized for the speaker or the media content, but is merely a sound quality mode selected by the user. Therefore, a technique for automatically setting the sound quality mode by the voice command is necessary.

### SUMMARY

A main object of the present disclosure is to provide a sound quality control method based on a voice command which automatically sets a play sound quality mode corresponding to media contents to be played based on the voice command and plays the media contents in a set play sound quality mode and an apparatus therefor.

According to an aspect of the present disclosure, in order to achieve the above-described objects, a sound quality control method based on a voice command includes: a voice command acquiring step of acquiring a voice command for playing media contents; a voice command analyzing step of analyzing the voice command to recognize the media contents and generating recognition result information for the media contents; a category determining step of determining a category for the media contents based on the recognition result information; and a sound quality setting control step of determining a play sound quality mode of the media contents based on a determination result of the category.

According to another aspect of the present disclosure, in order to achieve the above-described objects, a sound quality control apparatus based on a voice command includes: at least one or more processors; and a memory in which one or more programs executed by the processors are stored, wherein when the programs are executed by one or more processors, the programs allow one or more processors to perform operations including: a voice command acquiring step of acquiring a voice command for playing media contents; a voice command analyzing step of analyzing the voice command to recognize the media contents and generating recognition result information for the media contents; a category determining step of determining a category for the media contents based on the recognition result information; and a sound quality setting control step of determining a play sound quality mode of the media contents based on a determination result of the category.

According to another aspect of the present disclosure, in order to achieve the above-described object, a content playing apparatus includes: a sound quality control module which acquires a voice command for playing media contents, analyzes the voice command to generate a recognition result information for the media contents, determines a category for the media contents based on the recognition result information, and determines a play sound quality mode of the media contents based on a category determination result; and a content playing module which plays the media contents by applying the play sound quality mode.

As described above, according to the present disclosure, the sound quality mode (equalizer) may be automatically set in accordance with a voice command, without using the manipulation of the user.

Further, according to the present disclosure, an optimal sound quality mode associated with the genre of the media contents is set to play the media contents.

### BRIEF DESCRIPTION OF THE DRAWINGS

FIG. 1 is a block diagram schematically illustrating a content playing apparatus according to an exemplary embodiment of the present disclosure;

FIG. 2 is a block diagram for explaining a sound quality control apparatus according to an exemplary embodiment of the present disclosure;

FIG. 3 is a flowchart for explaining a sound quality control method based on a voice command according to an exemplary embodiment of the present disclosure;

FIG. 4 is an exemplary view illustrating an example of setting a sound quality based on a voice command according to an exemplary embodiment of the present disclosure;

FIG. 5 is an exemplary view for explaining an operation of analyzing a voice command according to an exemplary embodiment of the present disclosure; and

FIGS. 6A and 6B are exemplary views for explaining an operation of controlling a sound quality to play contents based on a voice command according to an exemplary embodiment of the present disclosure.

### DETAILED DESCRIPTION OF THE EMBODIMENT

Hereinafter, exemplary embodiments of the present disclosure will be described in detail with reference to the accompanying drawings. In the description of the present disclosure, if it is considered that the specific description of related known configuration or function may cloud the gist of the present disclosure, the detailed description will be omitted. Further, hereinafter, exemplary embodiments of the present disclosure will be described. However, it should be understood that the technical spirit of the invention is not restricted or limited to the specific embodiments, but may be changed or modified in various ways by those skilled in the art to be carried out. Hereinafter, a sound quality control method based on a voice command and an apparatus therefor proposed by the present disclosure will be described in detail with reference to drawings.

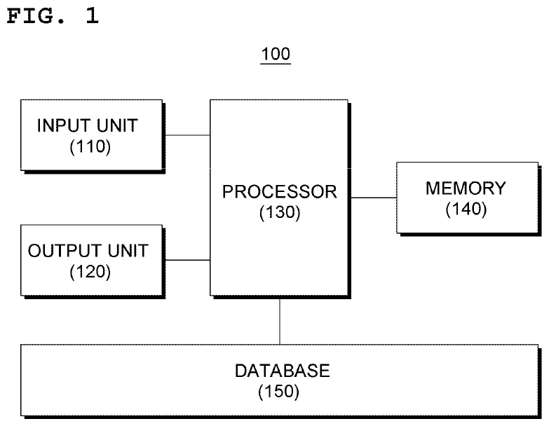

FIG. 1 is a block diagram schematically illustrating a content playing apparatus according to an exemplary embodiment of the present disclosure.

The content playing apparatus 100 according to the exemplary embodiment includes an input unit 110, an output unit 120, a processor 130, a memory 140, and a database 150. The content playing apparatus 100 of FIG. 1 is an example so that all blocks illustrated in FIG. 1 are not essential components and in the other exemplary embodiment, some blocks included in the content playing apparatus 100 may be added, modified, or omitted. In the meantime, the content playing apparatus 100 may be implemented by a computing device and each component included in the content playing apparatus 100 may be implemented by a separate software device or a separate hardware device in which the software is combined. For example, the content playing apparatus 100 may be implemented to be divided into a content play module which plays media contents and a sound quality control module which controls a play sound quality mode to play media contents.

The content playing apparatus 100 automatically sets a play sound quality mode of media contents in accordance with the voice command and performs an operation of playing media contents in a state that the play sound quality mode is set.

The input unit 110 refers to means for inputting or acquiring a signal or data for performing an operation of the content playing apparatus 100 of playing media contents and controlling a sound quality. The input unit 110 interworks with the processor 130 to input various types of signals or data or directly acquires data by interworking with an external device to transmit the signals or data to the processor 130. Here, the input unit 110 may be implemented by a microphone for inputting a voice command generated by the user, but is not necessarily limited thereto.

The output unit 120 interworks with the processor 130 to display various information such as media contents or a sound quality control result. The output unit 120 may desirably display various information through a display (not illustrated) equipped in the content playing apparatus 100, but is not necessarily limited thereto.

The processor 130 performs a function of executing at least one instruction or program included in the memory 140.

The processor 130 according to the present disclosure analyzes a voice command acquired from the input unit 110 or the database 150 to recognize the media contents and determines a category of the recognized media contents to perform an operation of setting a play sound quality mode. Specifically, the processor 130 acquires a voice command for playing media contents, analyzes the voice command to generate recognition result information for the media contents, determines a category for the media contents based on the recognition result information, and determines a play sound quality mode of the media contents based on the category determination result.

Further, the processor 130 performs an operation of playing media contents by applying the set play sound quality mode.

The processor 130 according to the present exemplary embodiment may simultaneously perform a content playing operation of playing media contents and a sound quality control operation of controlling a play sound quality mode to play the media contents, but is not necessarily limited thereto, and may be implemented by separate software or separate hardware to perform individual operations. For example, the processor 130 may be implemented by different modules or devices such as a media playing device and a sound quality control device.

The memory 140 includes at least one instruction or program which is executable by the processor 130. The memory 140 may include an instruction or a program for an operation of analyzing the voice command, an operation of determining a category for the media contents, and an operation of controlling the sound quality setting.

The database 150 refers to a general data structure implemented in a storage space (a hard disk or a memory) of a computer system using a database management program (DBMS) and means a data storage format which freely searches (extracts), deletes, edits, or adds data. The database 150 may be implemented according to the object of the exemplary embodiment of the present disclosure using a relational database management system (RDBMS) such as Oracle, Informix, Sybase, or DB2, an object oriented database management system (OODBMS) such as Gemston, Orion, or O2, and XML native database such as Excelon, Tamino, Sekaiju and has an appropriate field or elements to achieve its own function.

The database 400 according to the exemplary embodiment stores data related to the media content playing and the sound quality control and provides data related to the media content playing operation and the sound quality control operation.

The data stored in the database 400 may be data related to the learning for analyzing a voice command, previously defined category data, data for previously defined play sound quality mode, and a sound quality setting value for each play sound quality mode. It has been described that the database 250 is implemented in the content playing apparatus 100, but is not necessarily limited thereto and may be implemented as a separate data storage device.

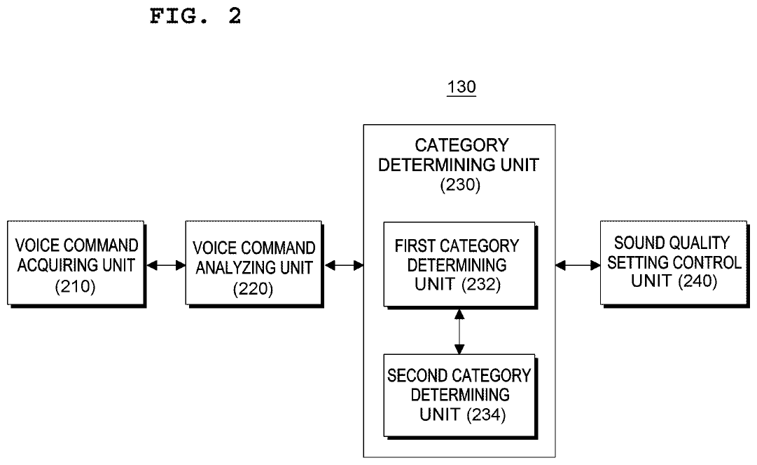

FIG. 2 is a block diagram for explaining a sound quality control apparatus according to an exemplary embodiment of the present disclosure.

The sound quality control apparatus 200 according to the exemplary embodiment includes a voice command acquiring unit 210, a voice command analyzing unit 220, a category determining unit 230, and a sound quality setting control unit 240. The sound quality control apparatus 200 of FIG. 2 is an example so that all blocks illustrated in FIG. 1->FIG. 2 are not essential components and in the other exemplary embodiment, some blocks included in the sound quality control apparatus 200 may be added, modified, or omitted. In the meantime, the sound quality control apparatus 200 may be implemented by a computing device and each component included in the sound quality control apparatus 200 may be implemented by a separate software device or a separate hardware device in which the software is combined.

The voice command acquiring unit 210 acquires a voice command for playing media contents. Here, the voice command acquiring unit 210 receives a voice command input by a voice receiving device (not illustrated) such as a microphone and the voice command is configured by voice data generated by the user. For example, the voice command may be “Play, OOO” and the “OOO” in the voice command may be information (a title, a field, or a type of contents) related to the media contents.

The voice command analyzing unit 220 analyzes the acquired voice command to recognize the media contents and generates recognition result information for the recognized media contents. Specifically, the voice command analyzing unit 220 extracts a feature vector for the voice command and analyzes the feature vector to generate the recognition result information for the media contents.

The voice command analyzing unit 220 analyzes the feature vector extracted from the voice command using an artificial intelligence neural network including a language model and a sound model which have been previously trained to generate the recognition result information for the media contents. Here, the recognition result information may be a content title, field information, genre information, sound source data information, and attribute information (a length and a file format) of the media contents.

The category determining unit 230 performs an operation of determining a category for the media contents based on the recognition result information. The category determining unit 230 determines the category for the field or the genre of the media contents. The category determining unit 230 according to the exemplary embodiment includes a first category determining unit 232 and a second category determining unit 234.

The first category determining unit 232 determines a main category for a play field of the media contents.

The first category determining unit 232 selects a main category using the content title and the field information included in the recognition result information. Here, the main category may be movies, music, sports, and news.

The second category determining unit 234 determines a subcategory for a subgenre of the media contents among a plurality of candidate subcategories. The plurality of candidate subcategories refers to subcategories related to the main category.

For example, when the main category is a “movie”, the candidate subcategory is configured by SF, romance, horror, and drama and when the main category is “music”, the candidate subcategory may be configured by POP, JAZZ, ROCK, and CLASSIC. Further, when the main category is “sports”, the candidate subcategory may be configured by soccer, basketball, baseball, and tennis and when the main category is “news”, the candidate subcategory may be configure by general, sports, weather, and entertainment.

The second category determining unit 234 according to the exemplary embodiment of the present disclosure selects a subcategory of the media contents corresponding to the genre information, among the plurality of candidate subcategories, using the genre information included in the recognition result information.

In the meantime, the second category determining unit 234 calculates a matching score for at least one candidate subcategory and selects a subcategory based on the calculated matching score. Specifically, the second category determining unit 234 calculates the matching score by matching media contents and each candidate subcategory using genre information and sound source data information included in the recognition result information and selects one candidate subcategory, among candidate subcategories, having a calculated matching score which is equal to or higher than a predetermined threshold value, as a subcategory. Here, when a plurality of candidate subcategories has a calculated matching score which is equal to or higher than a predetermined threshold value, the second category determining unit 234 may select a plurality of subcategories, but is not necessarily limited thereto. Therefore, one candidate subcategory having the highest matching score may be selected as a subcategory.

The sound quality setting control unit 240 determines a play sound quality mode of the media contents based on the category determination result.

The sound quality setting control unit 240 determines a play sound quality mode corresponding to the main category and the subcategory among a plurality of play sound quality modes which has been stored in advance.

When the plurality of subcategories is selected, the sound quality setting control unit 240 calculates an average of the sound quality setting values included in different play sound quality modes corresponding to the plurality of subcategories and determines the play sound quality mode which is reset based on the calculation result as a play sound quality mode of the media contents. Here, the sound quality setting value refers to a band (dB value) for the play sound quality mode and a frequency (Hz).

In the meantime, the sound quality setting control unit 240 acquires preferred sound quality information which has been set in advance by the user and determines the play sound quality by additionally considering the preferred sound quality information. Specifically, the sound quality setting control unit 240 finally determines a play sound quality mode which is reset by applying a preferred sound quality setting value included in the preferred sound quality information to the sound quality setting value included in the determined play sound quality mode among the plurality of previously stored play sound quality modes, as a play sound quality mode of the media contents.

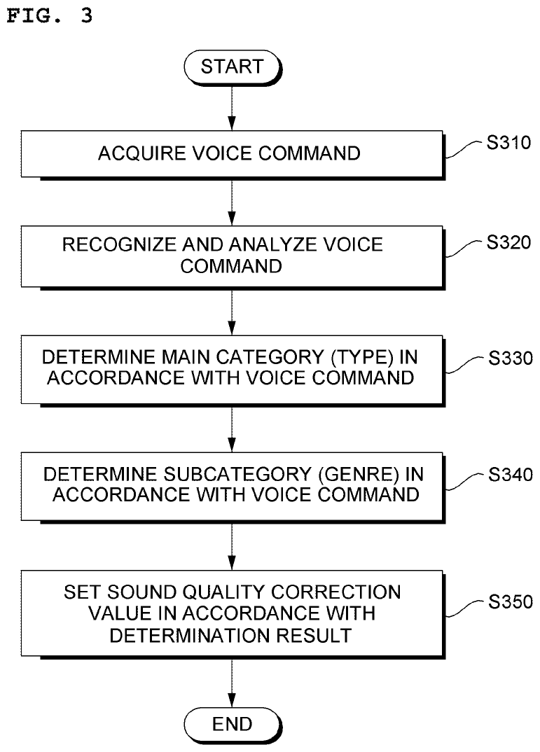

FIG. 3 is a flowchart for explaining a sound quality control method based on a voice command according to an exemplary embodiment of the present disclosure.

The sound quality control apparatus 200 acquires a voice command for playing media contents in step S310. The sound quality control apparatus 200 receives a voice command input by a voice receiving device (not illustrated) such as a microphone and the voice command is configured by voice data generated by the user.

The sound quality control apparatus 200 analyzes the acquired voice command to recognize media contents in step S320. The sound quality control apparatus 200 extracts a feature vector for the voice command, analyzes the extracted feature vector using an artificial intelligence neural network including a language model and a sound model which have been previously trained to generate the recognition result information for the media contents. Here, the recognition result information may be a content title, field information, genre information, sound source data information, and attribute information (a length and a file format) of the media contents.

The sound quality control apparatus 200 determines amain category for the media contents in accordance with the voice command in step S330. The sound quality control apparatus 200 selects a main category for a field of the media contents to be played using the content title and the field information included in the recognition result information. Here, the main category may be movies, music, sports, and news.

The sound quality control apparatus 200 determines a subcategory for the media contents in accordance with the voice command in step S340. The sound quality control apparatus 200 determines a subcategory for a subgenre of the media contents among the plurality of subcategories related to the main category. The sound quality control apparatus 200 may select the subcategory of the media contents corresponding to the genre information, among the plurality of candidate subcategories, using the genre information included in the recognition result information.

For example, when the main category is a “movie”, the candidate subcategory is configured by SF, romance, horror, and drama and when the main category is “music”, the candidate subcategory may be configured by POP, JAZZ, ROCK, and CLASSIC. Further, when the main category is “sports”, the candidate subcategory may be configured by soccer, basketball, baseball, and tennis and when the main category is “news”, the candidate subcategory may be configure by general, sports, weather, and entertainment.

The sound quality control apparatus 200 may select the subcategory of the media contents corresponding to the genre information, among the plurality of candidate subcategories, using the genre information included in the recognition result information.

In the meantime, the sound quality control apparatus 200 calculates a matching score for at least one candidate subcategory and selects a subcategory based on the calculated matching score. Specifically, the sound quality control apparatus 200 calculates the matching score by matching media contents and each candidate subcategory using genre information and sound source data information included in the recognition result information and selects one candidate subcategory, among candidate subcategories, having a calculated matching score which is equal to or higher than a predetermined threshold value, as a subcategory. Here, when a plurality of candidate subcategories has a matching score which is equal to or higher than a predetermined threshold value, the sound quality control apparatus 200 may select a plurality of subcategories, but is not necessarily limited thereto. Therefore, one candidate subcategory having the highest matching score may be selected as a subcategory.

The sound quality control apparatus 200 determines a play sound quality mode of the media contents based on the main category and the subcategory in step S350. The sound quality control apparatus 200 automatically set the play sound quality mode optimized for the media contents to play the media contents.

The sound quality control apparatus 200 determines a play sound quality mode corresponding to the main category and the subcategory among a plurality of play sound quality modes which has been stored in advance.

When the plurality of subcategories is selected, the sound quality control apparatus 200 calculates an average of the sound quality setting values included in different play sound quality modes corresponding to the plurality of subcategories and determines the play sound quality mode which is reset based on the calculation result as a play sound quality mode of the media contents. Here, the sound quality setting value refers to a band (dB value) for the play sound quality mode and a frequency (Hz).

In the meantime, the sound quality control apparatus 200 acquires preferred sound quality information which has been set in advance by the user and determines the play sound quality by additionally considering the preferred sound quality information. Specifically, the sound quality control apparatus 200 finally determines a play sound quality mode which is reset by applying a preferred sound quality setting value included in the preferred sound quality information to the sound quality setting value included in the determined play sound quality mode among the plurality of previously stored play sound quality modes, as a play sound quality mode of the media contents.

Even though in FIG. 3, it is described that the steps are sequentially performed, the present invention is not necessarily limited thereto. In other words, the steps illustrated in FIG. 3 may be changed or one or more steps may be performed in parallel so that FIG. 3 is not limited to a time-series order.

The sound quality control method according to the exemplary embodiment described in FIG. 3 may be implemented by an application (or a program) and may be recorded in a terminal (or computer) readable recording media. The recording medium which has the application (or program) for implementing the sound quality control method according to the exemplary embodiment recorded therein and is readable by the terminal device (or a computer) includes all kinds of recording devices or media in which computing system readable data is stored.

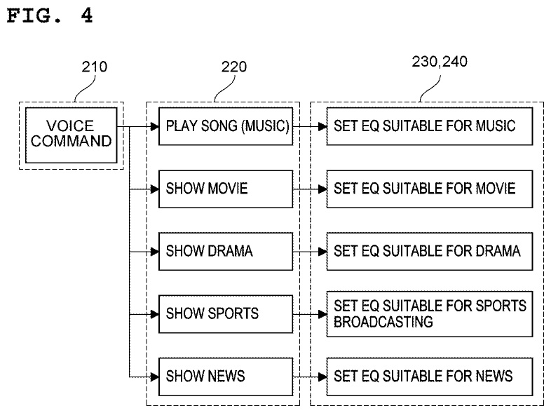

FIG. 4 is an exemplary view illustrating an example of setting a sound quality based on a voice command according to an exemplary embodiment of the present disclosure.

The sound quality control apparatus 200 acquires a voice command generated by the user by means of the voice command acquiring unit 210.

The sound quality control apparatus 200 analyzes the acquired voice command by the voice command analyzing unit 220. For example, the sound quality control apparatus 200 analyzes a voice command such as “play a song (music)”, “show a movie”, “show a drama”, “show sports”, or “show news”.

The sound quality control apparatus 200 selects a category for the voice command and sets a play sound quality mode corresponding to the selected category, by means of the category determining unit 230 and the sound quality setting control unit 240.

For example, when the voice command corresponds to a category for “music”, the sound quality control apparatus 200 sets a play sound quality mode optimized for the “music” to be played and when the voice command is a category for a “movie”, sets a play sound mode optimized for the “movie” to be played. Further, when the voice command corresponds to a category for “drama”, the sound quality control apparatus 200 sets a play sound quality mode optimized for the “drama” to be played, when the voice command is a category for “sports”, sets a play sound mode optimized for the “sports” to be played, and when the voice command is a category for “news”, sets a play sound mode optimized for the “news” to be played.

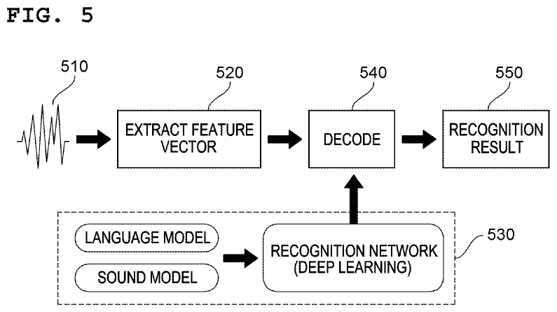

FIG. 5 is an exemplary view for explaining an operation of analyzing a voice command according to an exemplary embodiment of the present disclosure.

The voice command analyzing unit 220 of the sound quality control apparatus 200 extracts a feature vector 520 for the voice command 510.

The voice command analyzing unit 220 analyzes (510) the feature vector 520 extracted from the voice command using an artificial intelligence neural network 530 including a language model and a sound model which have been previously trained to generate recognition result information 550 for the media contents. Here, the recognition result information may be a content title, field information, genre information, sound source data information, and attribute information (a length and a file format) of the media contents.

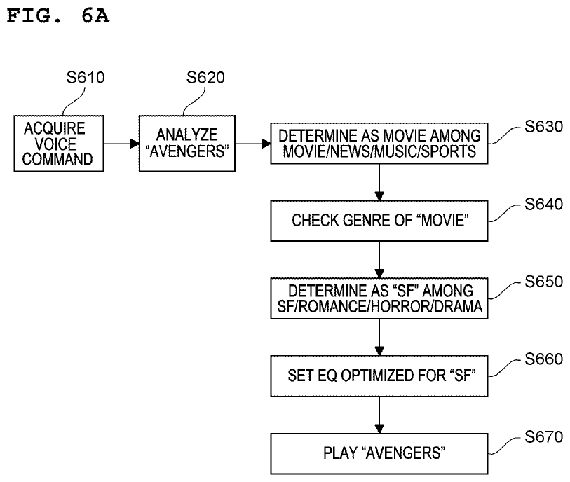

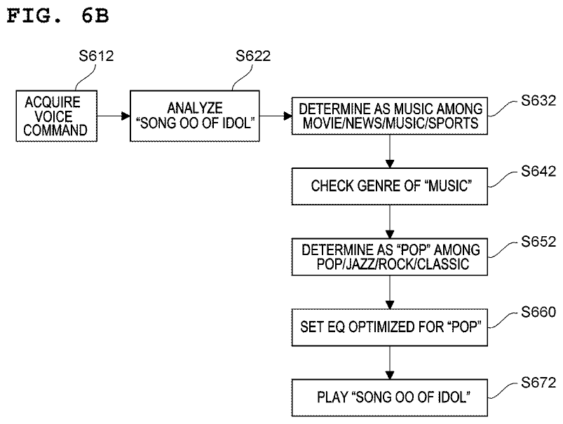

FIGS. 6A and 6B are exemplary views for explaining an operation of controlling a sound quality to play contents based on a voice command according to an exemplary embodiment of the present disclosure.

FIG. 6A is an exemplary view for explaining a sound quality control operation for the movie “Avengers”.

The sound quality control apparatus 200 acquires a voice command “play Avengers” in step S610 and analyzes the acquired voice command to generate recognition result information for the content “Avengers” in step S620.

The sound quality control apparatus 200 determines amain category for the “movie” among the movie, music, sports, and news based on the recognition result information for the content “Avengers” in step S630.

The sound quality control apparatus 200 checks the genre of the “movie” in step S640 and determines a subcategory for “SF” among “movie” genres including SF, romance, horror, and drama in step S650.

The sound quality control apparatus 200 sets a play sound quality mode (EQ) optimized for the “movie” and “SF” in step S660.

The sound quality control apparatus 200 plays the content “Avengers” in accordance with the voice command in a state in which the play sound quality mode is set in step S670.

FIG. 6B is an exemplary view for explaining a sound quality control operation for the music “song OO of idol”.

The sound quality control apparatus 200 acquires a voice command “play song OO of idol” in step S612 and analyzes the acquired voice command to generate recognition result information for the contents “song OO of idol” in step S6220.

The sound quality control apparatus 200 determines a main category for the “music” among the movie, music, sports, and news based on the recognition result information for the contents “song OO of idol” in step S632.

The sound quality control apparatus 200 checks the genre of the “music” in step S642 and determines a subcategory for “POP” among “music” genres including POP, JAZZ, ROCK, and CLASSIC in step S652.

The sound quality control apparatus 200 sets a play sound quality mode (EQ) optimized for the “music” and “POP” in step S662.

The sound quality control apparatus 200 plays the contents “song OO of idol” in accordance with the voice command in a state in which the play sound quality mode is set in step S672.

It will be appreciated that various exemplary embodiments of the present disclosure have been described herein for purposes of illustration, and that various modifications and changes may be made by those skilled in the art without departing from the scope and spirit of the present invention. Accordingly, the exemplary embodiments of the present disclosure are not intended to limit but describe the technical spirit of the present invention and the scope of the technical spirit of the present invention is not restricted by the exemplary embodiments. The protective scope of the exemplary embodiment of the present invention should be construed based on the following claims, and all the technical concepts in the equivalent scope thereof should be construed as falling within the scope of the exemplary embodiment of the present invention.

What is claimed is:

1. A sound quality control method based on a voice command in a sound quality control apparatus, the sound quality control method comprising:
a voice command acquiring step of acquiring a voice command for playing media contents;
a voice command analyzing step of analyzing the voice command to recognize the media contents by and generating recognition result information for the media contents;
a category determining step of determining a category for the media contents based on the recognition result information; and
a sound quality setting control step of determining a play sound quality mode of the media contents based on a determination result of the category.

2. The sound quality control method according to claim 1, wherein in the voice command analyzing step, a feature vector for the voice command is extracted and analyzed using an artificial intelligence neural network including a language model and a sound model which have been trained in advance to generate the recognition result information for the media contents.

3. The sound quality control method according to claim 1, wherein the category determining step includes:
a first category determining step of determining a main category for a playing field of the media contents; and
a second category determining step of determining a subcategory for a subgenre for the media contents, among a plurality of candidate subcategories related to the main category.

4. The sound quality control method according to claim 3, wherein in the first category determining step, the main category is selected using at least one information of a content title and field information included in the recognition result information and in the second category determining step, a matching score is calculated by matching the media contents and at least one classificable candidate subcategory and at least one candidate subcategory having a matching scorer which is equal to or higher than a predetermined threshold is selected as the subcategory.

5. The sound quality control method according to claim 3, wherein in the sound quality setting control step, among a plurality of previously stored play sound quality modes, a play sound quality mode corresponding to the main category and the subcategory is determined and applied to play the media contents.

6. The sound quality control method according to claim 3, wherein in the sound quality setting control step, when a plurality of candidate subcategories is selected as the subcategory, an average of the sound quality setting values included in different play sound quality modes corresponding to the plurality of candidate subcategories is calculated and the play sound quality mode which is reset based on the calculation result is determined as a play sound quality mode of the media contents.

7. The sound quality control method according to claim 5, wherein in the sound quality setting control step, preferred sound quality information which has been set in advance by a user is acquired and the play sound quality mode is determined by further considering the preferred sound quality information.

8. The sound quality control method according to claim 7, wherein in the sound quality setting control step, a play sound quality mode which is reset by applying a preferred sound quality setting value included in the preferred sound quality information to the sound quality setting value included in the determined play sound quality mode among the plurality of previously stored play sound quality modes is finally determined as a play sound quality mode of the media contents.

9. A sound quality control apparatus based on a voice command, the sound quality control apparatus, comprising:
at least one or more processors; and
a memory in which one or more programs executed by the processors are stored,
wherein when the programs are executed by one or more processors, the programs allow one or more processors to perform operations including:
a voice command acquiring step of acquiring a voice command for playing media contents;
a voice command analyzing step of recognizing the media contents by analyzing the voice command and generating recognition result information for the media contents;
a category determining step of determining a category for the media contents based on the recognition result information; and
a sound quality setting control step of determining a play sound quality mode of the media contents based on a determination result of the category.

10. An apparatus for playing contents by controlling a sound quality, comprising:
a sound quality control module which acquires a voice command for playing media contents, analyzes the voice command to generate a recognition result information for the media contents, determines a category for the media contents based on the recognition result information, and determines a play sound quality mode of the media contents based on a category determination result; and
a content playing module which plays the media contents by applying the play sound quality mode.
